(19) United States
(12) Patent Application Publication
(10) Pub. No.: US 2026/0026534 A1
(43) Pub. Date: Jan. 29, 2026

(54) JELLY BOBAS AND APPARATUS AND METHOD FOR PRODUCING SAME

(71) Applicant: Texture Maker Enterprise Co., Ltd., New Taipei City (TW)

(72) Inventors: Tien-Tzu Li, New Taipei City (TW); Hsiu-Wen Kang, New Taipei City (TW); Hung-An Chen, New Taipei City (TW); Yu-Hsuan Wu, New Taipei City (TW)

(21) Appl. No.: 19/344,024

(22) Filed: Sep. 29, 2025

Related U.S. Application Data
(62) Division of application No. 18/095,923, filed on Jan. 11, 2023, now abandoned.

(30) Foreign Application Priority Data
Oct. 3, 2022 (TW) 111137499

(51) Int. Cl. A23L 21/10

(52) U.S. Cl. CPC A23L 21/10

(57) ABSTRACT

A method for producing jelly bobas includes steps providing an apparatus for producing jelly bobas comprising a tank, a cutting set and a pool, wherein the tank comprises a main body and a bottom plate, the bottom plate comprises a plurality of holes and the cutting set is positioned under the bottom plate; continuously pouring a gel into the tank, wherein the gel has a viscosity ranged between 25000 and 95000 cps at 6 rpm or between 30000 and 180000 cps at 3 rpm as measured with LV-4 spindle of Brookfield Viscometer; the gel continuously passing through the plurality of holes by means of a gravity thereof; the cutting set continuously cutting off the gel passed through the plurality of holes in a rotation manner for continuously forming a plurality of jelly bobas; and the pool receiving the plurality of jelly bobas and a solidifying agent contained therein shaping the jelly bobas.

### CROSS-REFERENCE TO RELATED APPLICATION

This application is a divisional application of U.S. Application Ser. No. 18/095,923 filed on January 11, 2023, which claims priority from Taiwan Patent Application No. 111137499, filed on October 03, 2022. The entire contents of the above-mentioned patent applications are incorporated herein by reference for all purposes.

### FIELD OF THE INVENTION

The present disclosure relates to jelly bobas and an apparatus and a method for producing the same, and more particularly to an apparatus and a method for continuously producing jelly bobas and the jelly bobas produced thereby.

### BACKGROUND OF THE INVENTION

Boba tea is a famous drink from Taiwan. The bobas contained therein provide a chewing texture and is popular among publics. However, the traditional bobas are made of tapioca flours, so that the boba inconveniently has to be boiled and stewed for a long time before eating, and the boba is also a high calorie food which is easy to cause obesity if eaten frequently. Accordingly, the replacement for the boba is developed recently, such as kanten or konjac.

Jelly boba is a product made from a gel, such as kanten or konjac. It is advantageous of low calories, short preparation time, good variety of taste and similar texture to the traditional boba. Therefore, the jelly boba is suitable to be the replacement of the traditional boba for being added in the drink or cool treat.

Generally, the jelly bobas are formed through extrusion, such as described in Taiwan Patent No. I703935B, in titled “a method for producing jelly balls through extrusion”. In which, an extrusion machine is cooperated with a cutting machine to form the jelly balls. However, since the production of jelly balls through extrusion only can be performed in batch, the production capability is low. Therefore, there is a need of providing an improved apparatus and an improved method for producing jelly bobas.

### SUMMARY OF THE INVENTION

An object of the present disclosure is to provide jelly bobas and an apparatus and a method for producing the same, in which the jelly bobas are continuously produced from a gel having a reduced viscosity without employing extra forces other than the gravity of the gel itself.

Another object of the present disclosure is to provide an apparatus and a method for producing jelly bobas in which, in the case of the gel has the reduced viscosity, a forming speed and formed sizes of the jelly bobas are collaboratively decided by diameters of holes that the gel passes therethough and a rotation speed of a cutter.

In accordance with an aspect of the present invention, a method for producing jelly bobas is provided. The method includes steps providing an apparatus for producing jelly bobas comprising a tank, a cutting set and a pool, wherein the tank comprises a main body and a bottom plate, the bottom plate comprises a plurality of holes and the cutting set is positioned under the bottom plate; continuously pouring a gel into the tank, wherein the gel has a viscosity ranged between 25000 and 95000 cps at 6 rpm or between 30000 and 180000 cps at 3 rpm as measured with LV-4 spindle of Brookfield Viscometer; the gel continuously passing through the plurality of holes by means of a gravity thereof; the cutting set continuously cutting off the gel passed through the plurality of holes in a rotation manner for continuously forming a plurality of jelly bobas; and the pool receiving the plurality of jelly bobas and a solidifying agent contained therein shaping the jelly bobas.

In an embodiment, a temperature of the gel is maintained between 65℃ and 95℃ as the gel is accommodated in the tank.

In an embodiment, the tank has a height, and an amount of the gel in the tank is maintained at 60% to 80 % of the height of the tank.

In an embodiment, a composition of the gel includes water, a konjac gum, a sodium alginate, a locust bean gum, a gellan gum, a carrageenan, and a xanthan gum.

In an embodiment, diameters of the plurality of holes are ranged in 0.5-1.0 cm, and diameters of the plurality of jelly bobas are ranged in 0.7-1.3 cm.

In an embodiment, a rotation speed of the cutting set is ranged in 30-60 rpm.

In an embodiment, a temperature of the solidifying agent is ranged between 15℃ and 30℃.

In an embodiment, a composition of the solidifying agent includes water, a calcium hydroxide, a calcium lactate, a calcium chloride and a potassium chloride.

In accordance with another aspect of the present invention, a jelly boba prepared through the method described above is provided.

In accordance with a further aspect of the present invention, an apparatus for producing jelly bobas is provided. The apparatus includes a tank, a cutting set and a pool. The tank accommodates a gel and includes a main body and a bottom plate, wherein the bottom plate includes a plurality of holes, and the gel continuously passes through the plurality of holes by means of the gravity thereof. The cutting set includes a base and a cutter, wherein the cutting set is positioned under the bottom plate for continuously cutting off the gel passed through the plurality of holes in a rotation manner so as to continuously form a plurality of jelly bobas. The pool is positioned under the tank and accommodates a solidifying agent for receiving and shaping the plurality of jelly bobas. Further, the gel has a viscosity ranged between 25000 and 95000 cps at 6 rpm or between 30000 and 180000 cps at 3 rpm as measured with LV-4 spindle of Brookfield Viscometer.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic view showing an apparatus for producing jelly bobas according to an embodiment of the present disclosure;

FIG. 2 is a schematic view showing a tank and a cutting set according to an embodiment of the present disclosure; and

FIG. 3 is a flow chart showing a method for producing jelly bobas according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

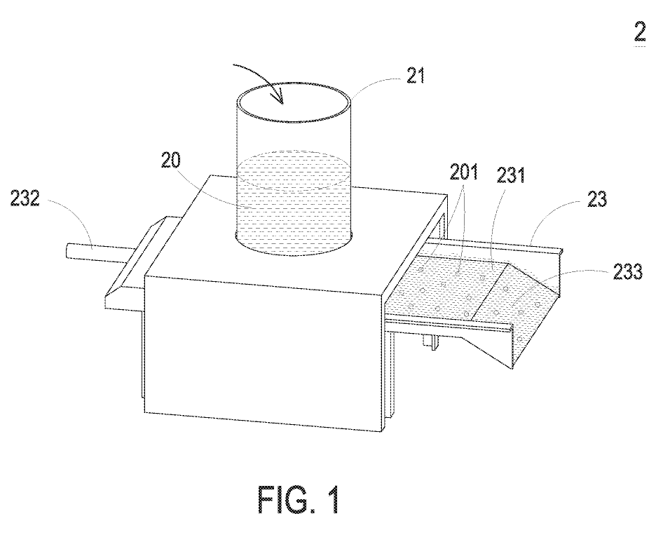

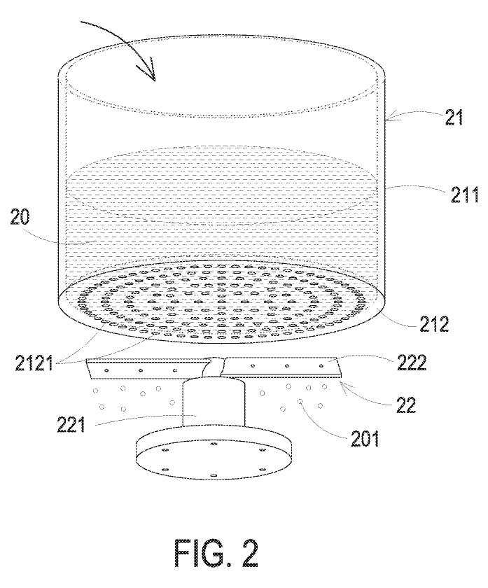

Please refer to FIG. 1 and FIG. 2. FIG. 1 is a schematic view showing an apparatus for producing jelly bobas according to an embodiment of the present disclosure, and FIG. 2 is a schematic view showing a tank and a cutting set according to an embodiment of the present disclosure. An apparatus for producing jelly bobas 2 includes a tank 21, a cutting set 22 and a pool 23. The tank 21 is used to accommodate a gel 20 and includes a main body 211 and a bottom plate 212, and the bottom plate 212 has a plurality of holes 2121 disposed thereon. The cutting set 22 includes a base 221 and a cutter 222 and is positioned under the bottom plate 212 for cutting off the gel 20 which passes through the plurality of holes 2121 so as to form jelly bobas 201. Notably, although, for clarity, FIG. 2 illustrates the cutting set 22 is disposed under the tank 21 with a distance, it is preferable that the cutting set 22 is installed as close to the bottom plate 212 as possible but still remains not colliding or rubbing against each other, so that the cutting set 22 can cut the gel 20 off at a best timing, and it also can avoid from temperature rising and/or apparatus damage due to collision or rubbing. Furthermore, the pool 23 is disposed under the tank 21 for accommodating a solidifying agent 231 so as to shape the cut gels 20, namely the jelly bobas 201, dropped into the pool 23, wherein the solidifying agent 231 flows in through a flow inlet 232 and flows out through a flow outlet 233.

After analyzing the prior art, it is known that the usage of the extrusion machine is the main reason why the production only can be performed in batch. Accordingly, in the present disclosure, the extrusion machine is removed, and the jelly bobas are produced in a situation that there is no extra force applied. It is found in the experiments that cooperation between the gravity and the viscosity of the gel 20 can achieve passages of the gel 20 through the plurality of holes 2121 without applying extra forces, thereby forming the jelly bobas 201.

As known, the gel used in the prior art has a higher viscosity with difficulty in passing through the holes under the tank rapidly, so the extrusion machine is employed therefor. Accordingly, in the present disclosure, it is tried to reduce the viscosity of the gel 20 so as to make the gel 20 to pass through the holes 2121 only by the gravity thereof. The experimental results also reveal that although the lower the viscosity of the gel 20, the easier the gel 20 passes through the holes 2121 without applying extra forces, it also becomes harder to form a particle shape for the gel 20. Therefore, the adjustment of the viscosity is the key point in the present disclosure.

Further, it is also found that when the viscosity is adjusted to be within an appropriate range, the amount of the gel 20 accommodated in the tank 21 has a few influence on the speed of the gel 20 passing through the holes 2121. Accordingly, in this situation, the amount of the gel 20 can be advantageously varied without limitation during the producing process of the jelly bobas.

On the other hand, when the gel 20 in the tank 21 is accumulated to a specific amount, the total weight of the gel 20 will form a downward force which is similar to the function of the extrusion machine, so that in some embodiments, the producing process of the jelly bobas also can be performed under a condition that the accumulated amount of the gel 20 is larger than a specific amount, such as, over 60% of the height of the tank, for further providing the downward force and make the producing process more smooth. In a preferable embodiment, the amount of the gel 20 is maintained at 60% to 80 % of the height of the tank during the producing process, that is, as shown by the arrows in FIG. 1 and FIG. 2, the gel 20 is continuously poured in and supplied from the outside. Consequently, in this situation, not only the purpose of continuous production is achieved, a continuous downward force also can be provided.

So far, it can be seen that reducing the viscosity of the gel 20 to obtain an appropriate viscosity is the prerequisite, and also the key factor, for achieving the target of continuous production of jelly bobas in the present disclosure.

Moreover, with the reduced viscosity of the gel 20 being capable of passing through the holes 2121 continuously, it further found that a forming speed and sizes of the jelly bobas can be controlled by adjusting the diameters of the holes 2121 and the speed of the cutting set 22 for cutting off the jelly bobas 201.

As known, the diameters of the holes 2121 under the tank 21 directly influence the diameters of the formed jelly bobas 201. However, different from the gel with higher viscosity in the prior art which is extruded to pass through holes to form jelly balls, the formation of the jelly bobas 201 of the present disclosure mainly depends on the cohesion of the gel 20 cooperating with the surface tension between the gel 20 and the solidifying agent 231, so that the gel 20 with reduced viscosity can be solidified to form the jelly bobas 201 at the time dropped from the holes 2121. Therefore, for accurately controlling the sizes of the jelly bobas 201, it is preferable to cut off the jelly bobas 201 by the cutter 222 of the cutting set 22 as the gel 20 just passed through the holes 2121. And, for continuously cutting off the jelly bobas 201 with similar sizes, the cutter 222 is preferably operated in a rotation manner.

Consequently, other than the viscosity of the gel 20, the diameters of the holes 2121 of the bottom plate 212 and the rotation speed of the cutter 222 are also the key points that influence the formation of the jelly bobas 201, especially the forming speed of the jelly bobas 201 and the sizes of the jelly bobas 201.

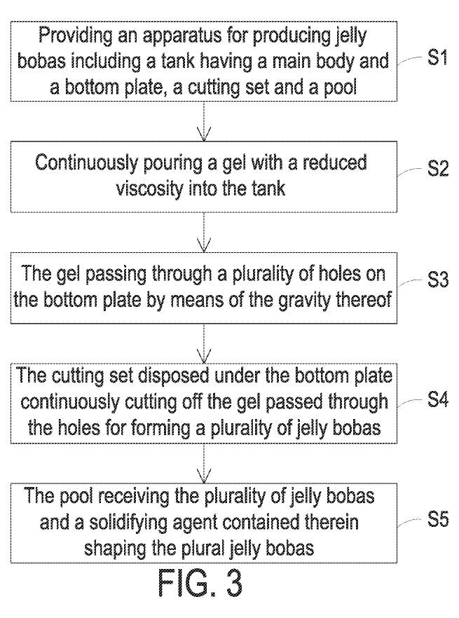

Accordingly, please refer to FIG. 3 which is a flow chart showing a method for producing jelly bobas according to an embodiment of the present disclosure. As shown, the method for producing jelly bobas includes steps S1 to S5. In step S1, the apparatus for producing jelly bobas including the tank 21, the cutting set 22 and the pool 23 is provided. In step S2, the gel 20 with a reduced viscosity is continuously poured into the tank 21. In step S3, the gel 20 continuously passes through the plurality of holes 2121 of the bottom plate 212 by means of the gravity thereof. In step S4, the cutting set 22 continuously cuts off the gel 20 passed through the holes 2121 to form the jelly bobas 201. Then, in step S5, the pool 23 receives the jelly bobas 201 and the solidifying agent 231 contained in the pool 23 shapes the jelly bobas 201.

The details of the viscosity of the gel, the diameters of the holes and the rotation speed of the cutter are described as follows.

Currently, there are various sizes of bobas in the market, and different sizes of bobas provide different chewing textures for different customers. The target of the present disclosure is to produce jelly bobas 201 having diameters close to those in the market. Accordingly, different diameters of the holes 2121 are used in the experiments to find a condition for producing jelly bobas with desired sizes. It is found that, within a specific range, the diameter and the viscosity have a positive correlation, namely, the larger the diameter, the higher the viscosity of the gel should have. Further, when the viscosity of the gel 20 is within the specific range, through cooperation between the diameters of the holes 2121 and the rotation speed of the cutter 222, it is able to form the jelly bobas having diameters close to those of bobas in the market only through the gravity of the gel 20 itself. Based on the experimental results, the best viscosity of the gel 20 is between 25000 and 95000 cps at 6 rpm or between 30000 and 180000 cps at 3 rpm as measured with LV-4 spindle of Brookfield Viscometer, and with this viscosity, the gel 20 can pass through the holes 2121 by means of the gravity thereof. For example, in some embodiments, this viscosity cooperating with the diameters of the holes 2121 ranged in 0.5-1 cm can form the jelly bobas 201 having diameters within 0.7-1.3 cm. In some other embodiments, this viscosity cooperating with the diameters of the holes 2121 ranged in 0.7-0.8 cm can form the jelly bobas 201 having diameters within 0.9-1.0 cm which generally can provide a better chewing texture.

For achieving this viscosity together with considering the chewing texture of the jelly bobas 201 after being shaped by the solidifying agent 231, the composition of the gel 20 preferably includes 76-99.7% of water, 0.05-4% of konjac gum, 0.05-4% of sodium alginate, 0.05-4% of locust bean gum, 0.05-4% of gellan gum, 0.05-4% of carrageenan, and 0.05-4% of xanthan gum, but not limited thereto. Simultaneously, the temperature of the gel 20 as being accommodated in the tank 21 is maintained between 65℃ and 95 ℃. For example, in some embodiments, the temperature of the gel 20 as being accommodated in the tank 21 is maintained between 65℃ and 75℃, in some other embodiments, the temperature is maintained between 75℃ and 85℃, and in some other embodiments, the temperature is maintained between 85℃ and 95℃. The appropriate temperature can be varied based on the practical condition without limitation.

Compared to the temperature of the gel in the prior art which is generally ranged between 45℃ and 65℃, the temperature of the gel 20 in the present disclosure is much higher, and with this temperature difference, the viscosity of the gel 20 can be effectively reduced, thereby achieving the target of passing through the holes 2121 by means of the gravity of the gel 20 itself.

Correspondingly, the rotation speed of the cutter 222 of the cutting set 22 is preferably ranged in 30-60 rpm for cooperating with different desired viscosity of the gel 20 and different desired diameters of the jelly bobas 201, so that the gel 20 which has passed through and stayed at the holes 2121 can be cut off timely, thereby forming the jelly bobas 201 with desired sizes.

When there is a need to produce the jelly bobas 201 of different diameters, it can be achieved by changing the bottom plate 212. In some embodiments, the method for producing the jelly bobas further includes steps of providing multiple bottom plates, in which the holes disposed on respective bottom plates have different diameters, and selecting one of the bottom plates to install at the bottom of the tank for obtaining the jelly bobas with a desired diameter matching to the selected bottom plate. In some other embodiments, it is also preferable that the holes 2121 having different diameters are simultaneously disposed on one bottom plate 212, so that a mixture of jelly bobas 201 with different diameters can be produced in one producing process, which is benefit of providing a comprehensive chewing texture.

Then, the jelly bobas 201 cut off by the cutting set 22 are dropped into the pool 23. The pool 23 contains the solidifying agent 231 for shaping the jelly bobas 201 and also for accomplishing the chewing texture of the jelly bobas 201. The composition of the solidifying agent 231 includes 80-99.8% of water, 0.05-4% of calcium hydroxide, 0.05-6% of calcium lactate, 0.05-6% of calcium chloride and 0.05-4% of potassium chloride, but not limited thereto. Further, the temperature of the solidifying agent 231 is maintained between 15℃ and 30℃ for shaping and cooling down the jelly bobas 201 at the same time. This process takes about one hour.

Because the cutter 222 of the cutting set 22 cuts off the gel 20 rotationally and continuously, the solidifying agent 231 in the pool 23 can be driven to flow, and thus, the cut-off jelly bobas 201 are also driven to flow with the solidifying agent 231 toward the flow outlet 233, thereby avoiding the jelly bobas 201 from accumulating under the tank 21, and also smoothing the producing process.

The different sizes of the shaped jelly bobas 201 are separated through a screening procedure. In one embodiment, the sizes of the jelly bobas 201 are separated through adjusting a mesh number of a screening machine. For example, based on the practical demands, the mesh number can be set between 0.7 and 1.3 cm, so as to screen out the jelly bobas with undesired sizes or to keep the jelly bobas having the sizes within a specific desired range. The jelly bobas 201 are also cleaned in this screening procedure.

After screening and cleaning, the jelly bobas 201 are packaged. The jelly bobas 201 are packaged with a preservation liquid in a bag. The composition of the preservation liquid includes water, anhydrous citric acid, calcium chloride, sodium metabisulfite, sucrose liquid, calcium lactate and potassium sorbate, but not limited thereto. Moreover, other than preserving the jelly bobas 201, the preservation liquid can further be used to provide the jelly bobas 201 a flavor. For example, an edulcorant or other flavor enhancers can be added in the preservation liquid while packaging so as to give the jelly bobas 201 therein the flavor.

Then, the packaged jelly bobas 201 and the preservation liquid are sterilized, for example, under 80℃ for 40 minutes, so as to finish the packaging procedure.

In conclusion, through varying the viscosity of the gel for producing the jelly bobas, the present disclosure achieves the target of continuously producing the jelly bobas without employing extra forces. Correspondingly, through adjusting the diameters of the holes passed therethrough by the gel and also the rotation speed of the cutter for cutting off the gel, the present disclosure also develops the apparatus and the method for continuously producing the jelly bobas with desired sizes so as to effectively improve the drawbacks in the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for producing jelly bobas, comprising steps of:
providing an apparatus for producing jelly bobas comprising a tank, a cutting set and a pool, wherein the tank comprises a main body and a bottom plate, the bottom plate comprises a plurality of holes, and the cutting set is positioned under the bottom plate;
continuously pouring a gel into the tank, wherein the gel has a viscosity ranged between 25000 and 95000 cps at 6 rpm or between 30000 and 180000 cps at 3 rpm as measured with LV-4 spindle of Brookfield Viscometer;
the gel continuously passing through the plurality of holes by means of a gravity thereof;
the cutting set continuously cutting off the gel passed through the plurality of holes in a rotation manner for continuously producing a plurality of jelly bobas; and
the pool receiving the plurality of jelly bobas and a solidifying agent contained therein shaping the jelly bobas.

2. The method as claimed in claim 1, wherein a temperature of the gel is maintained between 65℃ and 95℃ as the gel is accommodated in the tank.

3. The method as claimed in claim 1, wherein the tank has a height, and an amount of the gel in the tank is maintained at 60% to 80 % of the height of the tank.

4. The method as claimed in claim 1, wherein a composition of the gel comprises water, a konjac gum, a sodium alginate, a locust bean gum, a gellan gum, a carrageenan, and a xanthan gum.

5. The method as claimed in claim 1, wherein diameters of the plurality of holes are ranged in 0.5-1.0 cm, and diameters of the plurality of jelly bobas are ranged in 0.7-1.3 cm.

6. The method as claimed in claim 1, wherein a rotation speed of the cutting set is ranged in 30-60 rpm.

7. The method as claimed in claim 1, wherein a temperature of the solidifying agent is ranged between 15℃ and 30℃.

8. The method as claimed in claim 1, wherein a composition of the solidifying agent comprises water, a calcium hydroxide, a calcium lactate, a calcium chloride and a potassium chloride.

9. A jelly boba prepared through the method as claimed in claim 1.

10. The jelly boba as claimed in claim 9, wherein a temperature of the gel is maintained between 65℃ and 95℃ as the gel is accommodated in the tank.

11. The jelly boba as claimed in claim 9, wherein the tank has a height, and an amount of the gel in the tank is maintained at 60% to 80 % of the height of the tank.

12. The jelly boba as claimed in claim 9, wherein a composition of the gel comprises water, a konjac gum, a sodium alginate, a locust bean gum, a gellan gum, a carrageenan, and a xanthan gum.

13. The jelly boba as claimed in claim 9, wherein diameters of the plurality of holes are ranged in 0.5-1.0 cm, and diameters of the plurality of jelly bobas are ranged in 0.7-1.3 cm.

14. The jelly boba as claimed in claim 9, wherein a rotation speed of the cutting set is ranged in 30-60 rpm.

15. An apparatus for performing the method as claimed in claim 1.
